(19) United States
(12) Patent Application Publication
(10) Pub. No.: US 2008/0155405 A1
(43) Pub. Date: Jun. 26, 2008

(54) Method for Initializing an Electronic System Comprising Several Plug-Ins

(76) Inventors: Erwin Lock, Ludwigsburg (DE); David Rubia, Ludwigsburg (DE); Alexander Buechel, Ludwigsburg (DE); Volkmar Wuensch, Zwickau (DE); Bernd Doerr, Wallduern (DE)

Correspondence Address: KENYON & KENYON LLP, ONE BROADWAY, NEW YORK, NY, 10004, US

(21) Appl. No.: 11/792,737

(22) PCT Filed: Nov. 25, 2005
(86) PCT No.: PCT/EP05/56224

§ 371 Date: Jun. 8, 2007

(30) Foreign Application Priority Data
Dec. 15, 2004 (DE) 102004060301.4

(51) Int. Cl. G06F 3/00

(52) U.S. Cl. 715/700

(57) ABSTRACT

A method for initializing an electronic system which has a base interface and several module-like plug-ins connected to it. To allow for a flexible addition and removal of plug-ins, the base interface and the plug-ins exchange information in the process of initializing the system. The plug-ins communicate what processes (priority, time pattern etc.) they contain. In addition they communicate what quantities (variables, functions, structures etc.) they require for executing the processes and what quantities they are able to provide in the context of executing the processes. On the basis of the information received, the base interface connects the individual plug-ins with one another such that the plug-ins receive appropriate references as to where they may access the required quantities while executing the processes. The references are for example pointers to a memory area or pointers to a structure in another plug-in.

### FIELD OF THE INVENTION

The present invention relates to a method for initializing an electronic system which has a base interface and several module-like plug-ins connected to it. The present invention additionally relates to a communications protocol for execution on at least one computing device of an electronic system during the initialization of the electronic system. The electronic system includes a base interface and several module-like plug-ins connected to it. The present invention furthermore relates to a computer program for execution on a computing device of a data processing system. The computer program includes several plug-ins and a base interface, the plug-ins being connected to the base interface. Finally, the present invention also relates to an electronic system having a computing device for executing a communications protocol. The electronic system includes a base interface and several module-like plug-ins connected to it.

### BACKGROUND INFORMATION

In the automotive field, originally electronics were used only in the form of individual, electrified components, these components operating in an isolated manner and independently of one another. Later these components were increasingly integrated to form systems, the components in the systems being interconnected for the purpose of data exchange and mutual influence. Examples of such integrated systems are engine control systems, brake control systems or driver information systems. Currently, one may observe a trend executing the control tasks. Thus there exists an intelligence in the system layer, which is required for integrating the plug-ins into the total system. In other words, the functionalities of the plug-ins build on the functionalities of the system layer and even presuppose the latter. Thus the plug-ins must be adjusted to the functionalities of the system layer and cannot be used straight away in other electronic systems having other functionalities in the system layer. Prior to using the plug-ins in another system environment, a time-intensive and cost-intensive adaptation of the plug-ins is required. Furthermore it may be necessary to adapt the functionalities of the system layer as well when changing or complementing the functionalities of the first components since a reworking of the first components can affect the coordination of the components, that is, the system layer. Thus the known systems merely provide insular approaches for handling plug-ins, which are not readily transferable to other systems without extensive adaptations.

Moreover, in this electronic system, the initialization of the system and the mutual linkage of the plug-ins is not implemented by the plug-ins themselves, but solely by the system layer and/or an operating system layer below it. The initialization is thus centrally controlled, and there is no communication between the plug-ins of the system prior to or during the initialization.

### SUMMARY OF THE INVENTION

The present invention provides that the initialization of the electronic system may be implemented in a substantially more flexible manner than was previously possible. In particular, the mutual linkages of the plug-ins within the context of initialization are to be produced in a fully automatic manner without the electronic system having to have prior knowledge of the type and number of the connected plug-ins and their functionalities or processes.

To achieve this objective, starting from the method of the type mentioned at the outset, the present invention provides that
in initializing the electronic system, the plug-ins provide information to the base interface regarding:
   at least one functionality implemented by the respective plug-in;
   quantities required by the respective plug-in for implementing the at least one functionality;
   quantities provided by the respective plug-in following the implementation of the at least one functionality,
the base interface provides information to the individual plug-ins regarding:
   which of the remaining plug-ins provides a quantity required by the plug-in, and
a corresponding reference to the plug-in providing the quantity is stored in the plug-in that requires the quantity.

According to the method of the present invention, in the context of initializing the electronic system, first each of the plug-ins connected to the base interface is queried for certain information. This information concerns, for example, the functionalities or the corresponding processes implemented in the plug-in. Moreover, the information concerns the quantities ascertained by the execution of the processes and provided by the plug-in as well as the quantities, which the plug-in requires for implementing the functionalities or executing the processes. Quantities in the sense of the present invention are, for example, variables, functions, structures etc. The plug-ins of the electronic system according to the present invention therefore have an additional initialization functionality in order to respond to the respective queries of the base interface and to transmit the requested information.

Following the receipt of the information from a first plug-in, the base interface queries the remaining plug-in as to whether they are able to provide at least one of the required quantities. If this is the case, then the base interface provides the first plug-in with information regarding which of the remaining plug-ins provides the quantities required by the first plug-in. Then a corresponding reference is entered at a certain location in the first plug-in to those plug-ins that provide the required quantities. Thus a plug-in of the electronic system according to the present invention has the additional initialization functionality in order to store the received references to one or several plug-ins, which provide the quantities required by the plug-in, in a suitable location.

At least one empty field may be provided in the plug-in, where the reference may be stored. Every time that in the context of executing a process in a first plug-in a certain quantity is required from another plug-in, the quantity is obtained via the reference from the other plug-in. Of course, several references to various other plug-ins may also be stored in the plug-in, particularly if various quantities are required in a plug-in. The references to the other plug-ins may be of any type.

The method according to the present invention may be used to establish the linkages between the plug-ins in run time during the initialization of the electrical system, and indeed irrespective of which plug-ins are actually connected to the base interface, and without prior knowledge as to which plug-ins are connected. The method according to the present invention allows for maximum flexibility with respect to adding, removing and modifying plug-ins in an electronic system.

The plug-ins may take the form of hardware (e.g. as plug-in cards having additional input/output interfaces, additional drivers, additional memory or computing capacities etc. for a control unit) or software (e.g. as operating sub-modules of a computer program). The base interface has no functionality for supplementing the functionalities of the plug-ins. The task of the base interface merely concerns the linkage of the plug-in during initialization and the communication between the plug-ins during the operation of the electrical system. The base interface obtains the information about the plug-ins required for this purpose directly from the plug-ins during the initialization phase of the electronic system by communicating with the plug-ins.

An advantageous refinement of the present invention provides for the at least one functionality to be implemented by at least one process. That is to say that the functionalities of the plug-ins are implemented by one or several processes. The transmission of information regarding the functionality of the plug-ins thus concerns any information regarding the processes implemented in the plug-in. The information concerning the functionality of the plug-ins advantageously include a time pattern, in which the at least one process is executed, and a priority of the at least one process.

An exemplary embodiment of the present invention provides that, in the plug-in requiring a specific quantity, a pointer is stored as a reference to a memory location in which the required quantity is stored by one of the remaining plug-ins.

The memory location to which reference is made may be provided in one of the plug-ins, but also in the base interface or a subordinate base functionality or base software. Working with pointers has several advantages. One advantage lies in the fact that when updating the software in a plug-in the old software may remain in the memory, the new software being stored in another, new location in the memory and the pointer being simply changed over to the new memory location. A fresh programming (so-called flashing) of the entire memory (erasing the old content and writing the new software) is thus not required.

Another exemplary embodiment of the present invention provides that, in the plug-in that requires a quantity, a pointer is stored as reference to a structure in which in a predefined position the required quantity is stored by one of the remaining plug-ins. Thus, this specific embodiment does not store, for each required quantity, a separate pointer to a memory location where the required quantity is stored, but rather stores merely a single pointer to a structure where all required quantities are stored. The structure includes a certain number of field, certain quantities being stored in certain fields. Thus a prior definition, for example, determines that a quantity A is always stored in the third position in the structure. If in a plug-in the quantity A is required, then the system jumps from the plug-in to the start of the structure to which the pointer points. Depending on the required quantity, the system jumps to the corresponding position or the corresponding field of the structure, that is, for the quantity A, the system jumps to the third position, the required quantity is read out and the system then returns to the plug-in. The structure may be contained in the base interface or the subordinate base functionality or base software. The content of the structure is continually updated by the plug-ins that supply the corresponding quantities. This specific embodiment has the advantage that in the plug-ins only one field is required for the pointer, which points to the start of the structure, even if more than one quantity is required in the plug-in.

If a particular quantity is provided by several plug-ins, then the question arises which of the plug-ins is to provide the quantity to the remaining plug-ins that require the quantity. In such a case, the quantity of that plug-in is advantageously chosen for further processing whose process for ascertaining the quantity has the highest priority. Since this process has the highest priority, it will be able to provide the required quantity prior to the other processes.

Furthermore it may be advantageous under certain conditions to have the quantity in such a case provided by the particular plug-in from which the base interface first receives the information that the plug-in or a process of the plug-in is able to provide the required quantity. Alternatively, the present invention provides for the quantity to be provided by the particular plug-in which is last to provide the base interface with the information that the plug-in or a process of the plug-in is able to provide the required quantity.

It is useful that the base interface has access to an initialization table containing information as to where the individual plug-ins are stored. This table may be updated when flashing new plug-ins if the plug-ins take the form of software. In the case of plug-ins in the form of software, but also in the form of hardware, it is also conceivable, however, that the plug-ins connected to the base interface and their (start) addresses are ascertained at the beginning of initialization and that the table is updated accordingly. The table which may be stored in the base interface. On the basis of this table, the base interface is then able to query the individual plug-ins and to retrieve the desired information.

If the electronic system takes the form of a computer program, then it is conceivable to structure the computer program into a base software without plug-ins, a superposed master interface and plug-ins and/or sub-interfaces connected to it, to which additional sub-interfaces and/or additional plug-ins are connected. The base software includes a fixed, permanent part of the software, which is responsible, for example, for communication via bus drivers etc. In this manner, a cascaded structure of the electronic system may be obtained, as it were. For this structure it is possible to implement a visibility concept, which makes it possible to limit the visibility of particular quantities from below, that is from higher-ranking areas, to particular lower-ranking areas of the structure. In this regard, a method for initializing an electronic system including a base interface and several module-like plug-ins connected to it are provided, one of the base interface taking the form of a master interface and the remaining base interfaces taking the form of sub-interfaces, and the master interface having in addition to the plug-ins also sub-interfaces connected to it, to which in turn further sub-interfaces and/or further plug-ins and so on are connected. The interfaces are divided into different areas (e.g. private, public, protected etc.). Only the quantities (variables, functions etc.) applied within the same area of the interfaces are visible and thus also accessible to subordinate (that is, higher-ranking) interfaces. The same quantity may apply to different areas of an interface. This makes it possible for the quantities in particular areas to be encapsulated, thus resembling local variables, as it were.

Advantageously, the interfaces are divided into a private area and a public area. Only the quantities (variables, functions etc.) applied in the public area of an interfaces are visible and thus also accessible to a subordinate interface. The private quantities applied in the private area of the interface are only visible in the respective interface and public areas from superposed interfaces.

Using this cascaded structure of the electronic system of the division of the interfaces into a private and a public area it is possible, for example, to create closed program areas in a computer program. This is advantageous if a particular program area is developed and programmed by external suppliers. For the customer it is not important how the design, the structure and the actual programming (what quantities, functions, structures were used, what algorithms are executed etc.) are implemented in detail. What is important is only that the program area fulfills the functionality required of it, that is, that the required processes are implemented in it and that it provides subordinate (that is, higher-ranking) interfaces with the required public quantities.

A subordinate interface only has access to the quantities applied in the public areas of the superordinate interfaces. The quantities applied in the private areas are not visible and thus also not accessible to the subordinate interface. Thus this allows for a simple encapsulation of program areas and of the functionalities implemented within them. With the aid of this visibility concept, the externally developed program areas may also be integrated readily and quickly into an existing computer program.

To facilitate the handling of the quantities within the plug-ins and the base interface, the present invention provides for an identifier that is unique for a defined area of the electronic system to be assigned to each of the quantities required by the plug-ins or provided by the plug-ins. The defined area which may be the area of the electronic system that is closed by the visibility concept. The identifier includes, for example, an identification number and an indication whether the quantity is public or private. It is of course conceivable to assign such or a different unique identifier not only to the variables, but also to functions, structures etc.

The identifiers of the quantities are advantageously stored in an identifier list, which the base interface is able to access during the initialization of the electronic system. It is conceivable that all quantities theoretically available in the electronic system (variables, functions etc.) are listed and explained in the identifier list. The list is prepared for the entire system and not for the currently connected plug-ins. Consequently, it always has the same content irrespective of the type and number of connected plug-ins. To this extent one can also say that in the present invention, the base interface has no prior information available regarding the actually connected plug-ins.

The list mainly represents the basis for an interface declaration or interface definition and serves as a basis both for the supplier of software or plug-ins as well as for the integrator.

As another approach to the objective of the present invention, starting from the communications protocol of the type mentioned at the outset, the present invention provides for the communications protocol to be programmed in such a way that
in the initialization of the electronic system, the plug-ins provide information to the base interface regarding:
   at least one functionality implemented by the respective plug-in;
   quantities required by the respective plug-in for implementing the at least one functionality;
   quantities provided by the respective plug-in following the implementation of the at least one functionality,
the base interface provides information to the individual plug-ins regarding:
   which of the remaining plug-ins provides a quantity required by the plug-in, and
a corresponding reference to the plug-in providing the quantity is stored in the plug-in that requires the quantity.

As yet another approach to achieving the objective of the present invention, starting from the computer program of the type mentioned at the outset, the present invention provides that
in the initialization of the electronic system, the plug-ins provide information to the base interface regarding:
   at least one functionality implemented by the respective plug-in,
   quantities required by the respective plug-in for implementing the at least one functionality, and
   quantities provided by the respective plug-in following the implementation of the at least one functionality;
the base interface provides information to the individual plug-ins regarding:
   which of the remaining plug-ins provides a quantity required by the plug-in; and
a corresponding reference to the plug-in providing the quantity is stored in the plug-in that requires the quantity.

Thus, in this case, the electronic system takes the form of a computer program such that the plug-ins are operating sub-modules of a computer program. Accordingly, the present invention is therefore implemented by the computer program.

As another approach to achieving the objective of the present invention, starting from the electronic system of the type mentioned at the outset, the present invention provides that
in the process of the initialization of the electronic system, the plug-ins provide the base interface with information regarding:
   at least one functionality implemented by the respective plug-in;
   quantities required by the respective plug-in for implementing the at least one functionality;
   quantities provided by the respective plug-in following the implementation of the at least one functionality,
the base interface provides information to the individual plug-ins regarding:
   which of the remaining plug-ins provides a quantity required by the plug-in, and
a corresponding reference to the plug-in providing the quantity is stored in the plug-in that requires the quantity.

Exemplary embodiments of the present invention are explained in more detail in the following and on the basis of the figures.

### BRIEF DESCRIPTION OF THE DRAWINGS

FIG. 1 shows an electronic system of the present invention according to a first exemplary embodiment.

FIG. 2 shows the construction of a plug-in.

FIG. 3 shows a flow chart of a method of the present invention according to an exemplary embodiment.

FIG. 4 shows an electronic system of the present invention according to another exemplary embodiment.

### DETAILED DESCRIPTION

In control units, particularly in motor vehicle control units, plug-and-play mechanisms are implemented both for software as well as for hardware according to the related art. This makes it possible, for example, to provide an additional or another functionality in a control unit by simply programming an operating sub-module (a so-called plug-in). In such a case, the plug-in component would take the form of software.

It is likewise possible to change or extend the functionality of the control unit by mechanically inserting and electrically contacting an additional hardware module. In such a case, the plug-in component would take the form of hardware. A particular field of application of plug-in components may be in a control unit network, where additional control units may be added and may be connected to the other control units via a CAN bus. This allows for additional or other functionalities to be provided to the control unit network.

The known plug-in mechanisms, however, have the disadvantage that both the functionalities as well as the interfaces of the plug-ins, that is, what quantities they are able to provide and what quantities they require, must be known in advance and appropriate resources must be held in reserve, regardless of whether the plug-in components are actually connected or not. In this context, in advance means at the time of the integration of a new plug-in component. In other words, before the new plug-in can be integrated, the mentioned items of information must be known. For this reason, the information is held in reserve in a central location in the electronic system, from where it may be retrieved when needed.

An example for such a known plug-in mechanism is for example the integration of an ACC (adaptive cruise control) function into an existing control unit network in a motor vehicle. As soon as the hardware components required for the ACC function are installed into the motor vehicle, they transmit, either immediately or only after a renewed startup of the system, defined CAN messages, which activate in an engine control the corresponding functionalities in a computer program or the interfaces of the functionalities. Disadvantageous in this context, however, is the fact that irrespective of whether the ACC hardware is installed in the motor vehicle or not, the ACC functionality must always be present in the computer program, or the corresponding operating sub-modules (plug-ins), in the engine control. That is to say that even if a particular functionality is not implemented in a motor vehicle, corresponding resources must be provided and held in reserve, in order to activate the desired functionality if needed.

In addition, it is disadvantageous in the known plug-in mechanisms that a functionality to be integrated always also requires a manual modification of the remaining system, for example, an integration of the new processes of the additionally provided operating sub-modules (plug-ins). A later integration of an additional functionality into an already programmed (flashed) control unit, that is, a so-called update or upgrade in the field, is likewise not possible or possible only at great cost.

This is precisely where the exemplary embodiment and/or exemplary method of the present invention finds its starting point. It allows for a simple, fully automatic integration of new plug-ins into an already existing system executed in run time during the initialization of the electronic system. In addition, the exemplary embodiment and/or exemplary method of the present invention offers the precondition for a particularly advantageous visibility concept for the quantities used in the system (for example, variables, functions, structures etc.).

With the aid of the exemplary embodiment and/or exemplary method of the present invention, new or modified functionalities may be integrated in a control unit via additional plug-ins without the interfaces or processes having to be known in advance to the rest of the system of this control unit. The provided concept allows for later updates and upgrades of functionalities, without requiring the entire control unit to be freshly programmed (flashed) for this purpose, in a garage, for example. After the new functionalities have been downloaded into the control unit, they automatically register in the system and are subsequently fully functional. The exemplary embodiment and/or exemplary method of the present invention in particular provides mechanisms for automatically coordinating the variable accesses and for automatically integrating the processes while taking into consideration priorities of processes and variables.

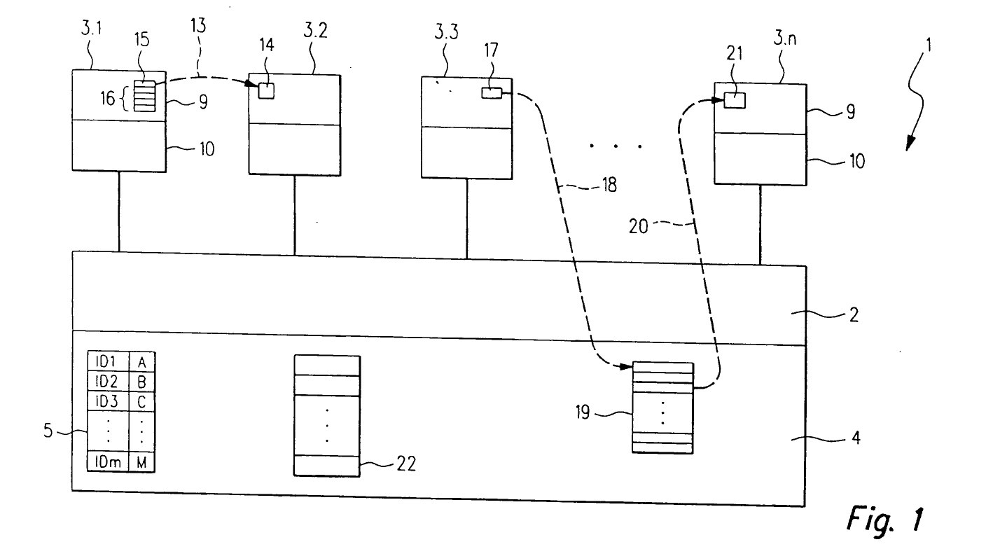

In FIG. 1, an electronic system according to the present invention is designated in its entirety by reference numeral 1. System 1 encompasses a base interface 2 and several plug-in components (in short: plug-ins) 3.1 through 3.n connected to it. The electronic system 1 may be implemented as hardware, plug-ins 3.1 through 3.n then representing hardware components, which may be mechanically inserted into an existing system and electronically contacted. An example for such a plug-in implemented in hardware is, for example, a plug-in card having processor, memory and computer program for controlling and/or regulating an ACC functionality in a motor vehicle. The additionally provided processor prevents the other processor(s) of electronic system 1 from being overloaded by the additional ACC functionality. Normally, the integration of an additional hardware plug-in goes hand in hand with the integration of a corresponding software plug-in.

In the exemplary embodiment shown in FIG. 1, plug-ins 3.1 through 3.n, however, are implemented as software. The entire electronic system 1 is thus a computer program, the functionality of which may be extended, modified or reduced by adding or removing plug-ins 3.1 through 3.n.

Below base interface 2, a base software 4 is provided, which encompasses a fixed, permanent part of the computer program, which is not changed by adding or removing plug-ins. The base software concerns for example the communication via bus drivers (for example a CAN software). Moreover, base software 4 defines the manner in which plug-ins 3.1 through 3.n communicate with the rest of the computer program, regardless of the number and the type of connected plug-ins 3.1 through 3.n. Moreover, base software 4 includes a so-called identifier list 5, which base interface 2 is able to access at least indirectly during the initialization of electronic system 1. In identifier list 5, all quantities (variables, functions etc.) theoretically available in electronic system 1 are listed (cf. left column of identifier list 5; ID1 through IDm) and explained (cf. right column of identifier list 5; A, B, C through M) Identifier list 5 is generated for the entire system 1 and not for currently connected plug-ins 3.1 through 3.n. Consequently, it always has the same content irrespective of the type and number of connected plug-ins 3.1 through 3.n. To be more precise, the quantities are solved via the corresponding names or IDs. These names or IDs are agreed upon in advance and are managed in identifier list 5.

Base interface 2 is superposed on base software 4 of electronic system 1 and is responsible for resolving the interfaces between the individual plug-ins 3.1 through 3.n. Base software 4 represents the part of the computer program that is not structured according to the plug-in concept (for example low-level software).

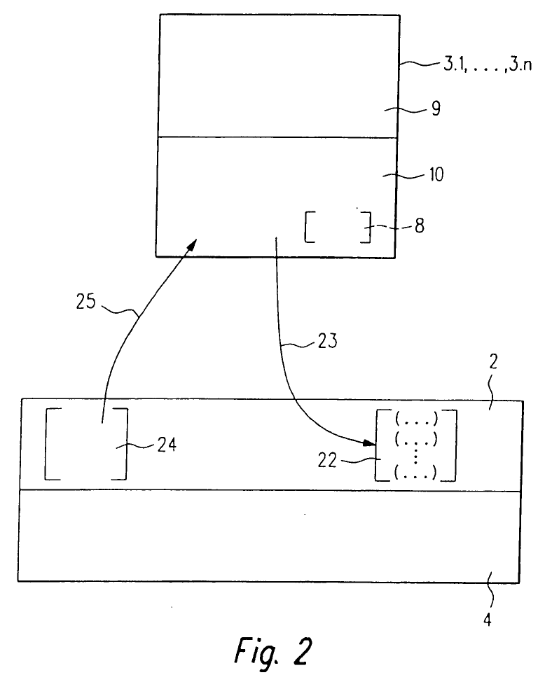

The exemplary embodiment and/or exemplary method of the present invention distinguishes between the actual plug-in part 9 and plug-in interface 10. The construction of plug-in 3.1 through 3.n is shown in more detail in FIG. 2. Part 9 of plug-in 3.1 through 3.n contains the actual functionality of plug-in 3.1 through 3.n and part 10 the actual initialization function. Part 9 of plug-ins 3.1 through 3.n includes at least one additional or modified functionality, which is to be made available to system 1 during the run time. This functionality may be implemented by one or several processes, which are contained in part 9 for the functionality. Plug-in interface 10 has no functionality for the run time of the computer program, but rather contains the information 8 (as e.g. the utilized quantities of functionality 9), which is required for initializing the function. The initialization itself is performed by base interface 2.

Starting out from initialization function 10, a so-called initialization table 22 is called (reference numeral 23). Base interface 2 knows the addresses of the initialization functions from initialization table 22. As an argument, call 23 includes a pointer to initialization routines, which are stored in another table 24. The initialization routines from table 24 contain the actual functionality of the initialization functions. An address (or a pointer) to the corresponding initialization routine in table 24 is then returned from base interface 2 to initialization function 10 (reference numeral 25).

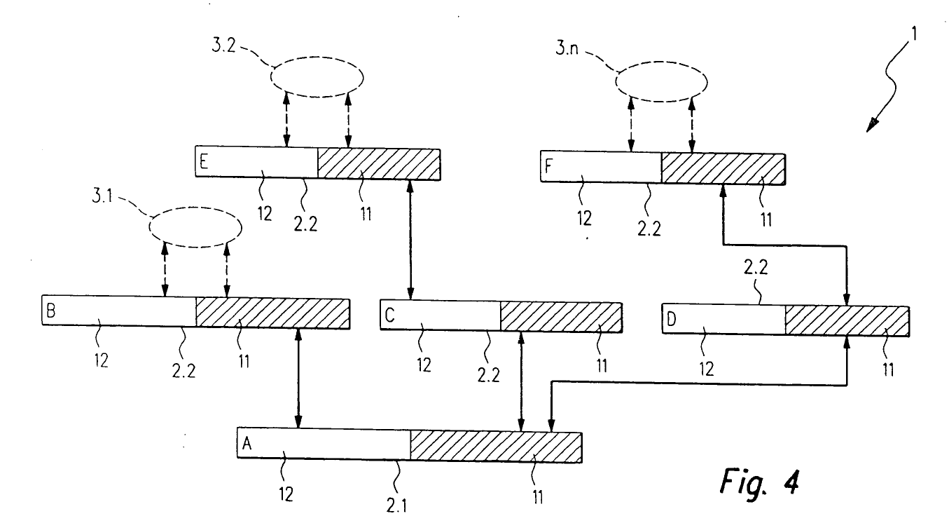

FIG. 4 shows another electronic system 1 of the present invention according to another exemplary embodiment. System 1 includes a plurality of base interfaces 2 superposed in a cascading arrangement. A lower base interface 2 is configured as a master interface 2.1. Base interfaces 2 arranged above it are configured as so-called sub-interfaces 2.2. Plug-ins 3.1 through 3.n and/or sub-interfaces 2.2 are connected to all interfaces 2.1, 2.2. Plug-ins 3.1 through 3.n connected to interfaces 2.1, 2.2 are represented in FIG. 4 merely symbolically by a dashed line and in small numbers. Thus, in the system structure represented in FIG. 4, some plug-ins 3.1 through 3.n are not directly connected to master interface 2.1 but only indirectly via sub-interfaces 2.2.

Interfaces 2.1, 2.2 encompass various areas. The visibility concept makes it possible to use several mutually delimited variable areas, for example, public, private, protected etc.). For this purpose, the variables are encapsulated in the respective areas.

In the exemplary embodiment shown in FIG. 4, interfaces 2.1, 2.2 are divided merely into two different areas, that is, public area 11 and private area 12. Only the public quantities applied in public area 11 of an interface 2.1, 2.2 are visible for a subordinate (and therefore higher-ranking) interface 2.1, 2.2.

Thus, following initialization, the following views are provided in system 1 from FIG. 4: Public area 11, starting at master interface 2.1, extends across public areas 11 of sub-interfaces 2.2 designated by C, D and F. That is to say that from public area 11 of master interface A it is possible to gain access to public area 11 of sub-interface C as well as to public area 11 of sub-interface D. In other words, the public areas of sub-interfaces C, D are accessible from the public area 11 of master interface A. Public area 11 of sub-interface F is visible for public area 11 of sub-interface D.

Public area 11 of sub-interface E is visible for sub-interface C, but not for master interface A. The reason for this is that the quantities applied in public area 11 of sub-interface E are applied in private area 12 of sub-interface C and are therefore not visible from the interface A below it. Private area 12, beginning at master interface A, extends across private area 12 of master interface A and public area 11 of sub-interface B.

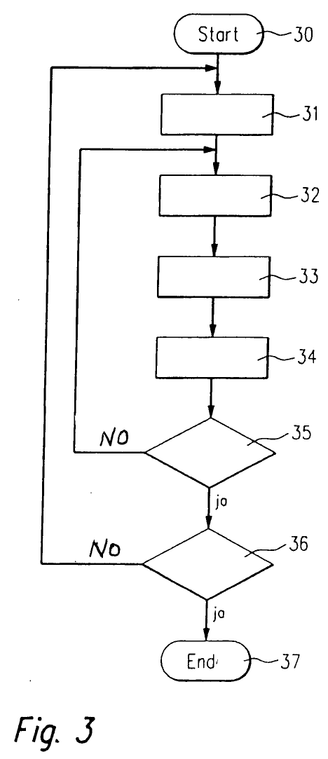

The initialization method for an electronic system 1 according to the exemplary embodiment and/or exemplary method of the present invention is explained in more detail below with reference to the flow chart from FIG. 3. The method begins in a functional block 30. In a functional block 31, base interface 2 or master interface 2.1 turns to a first plug-in 3.1 or to a sub-interface 2.2 of electronic system 1. Plug-in 3.1 transmits information about the processes it executes to base interface 2. This information concerns, for example, the time pattern of the processes, the priorities of the individual processes etc. In addition, plug-in 3.1 communicates in a functional block 32, what quantities (variables, functions, structures etc.) it requires to execute the processes.

Sub-interfaces 2.2 are treated the same way as plug-ins 3.1 through 3.n. A sub-interface 2.2 also transmits information to subordinate (i.e. higher-ranking) base interface 2 regarding the processes that are executed by the plug-ins connected to sub-interface 2.2. In addition, sub-interface 2.2 communicates what quantities are needed by the plug-ins connected to it for executing their processes.

In functional block 32, plug-in 3.1 begins with the transmission of the first required quantity to base interface 2. For this purpose, plug-in 3.1 transmits the corresponding identifier of the quantity to base interface 2. Then, in a functional block 33, all other plug-ins 3.2 through 3.n are queried in succession or all sub-interfaces 2.2 connected to base interface 2 are queried in succession as to whether they are able to provide the required quantity.

As soon as a plug-in 3.2 through 3.n has been found, which is able to provide the required quantity, the further search can be stopped. It may also be stopped if a sub-interface 2.2 was found, which is able to provide the required quantity. In this case, the respective plug-in 3.2 through 3.n or the respective sub-interface 2.2 would supply the required quantity, which is the first to inform base interface 2 that it is able to provide the required quantity.

It is also conceivable, however, that the search is continued until all further plug-ins 3.2 through 3.n and all sub-interfaces 2.2 are queried as to whether they are able to provide the required quantity. Out of all the plug-ins 3.1 through 3.n and sub-interfaces 2.2, which are able to provide the required quantity, the plug-in or the sub-interface 2.2 may be selected that has the process for ascertaining the required quantity having the highest priority. In this case, the plug-in 3.2 through 3.n or the sub-interface 2.2 having the highest-priority process for ascertaining the required quantity would be selected.

Finally, it is also conceivable that simply the last plug-in 3.2 through 3.n, which is able to provide the required quantity, is chosen. Alternatively, the last sub-interface 2.2 to be able to provide the required quantity could also be selected.

When searching for a plug-in 3.2 through 3.n, which is able to provide the required quantity, or for a sub-interface 2.2, which is able to provide the required quantity, base interface 2 may also distinguish between public and private quantities. This means that base interface 2 queries plug-ins 3.1 through 3.n and sub-interfaces 2.2 as to whether they are able to provide the required quantity in the desired (private or public) area.

The crucial point is that a plug-in 3.2 through 3.n or a sub-interface 2.2 is selected, which provides a specific quantity that plug-in 3.1 requires while executing its processes. During the execution of its processes, plug-in 3.1 must be able to access the quantity provided.

For this purpose, in a functional block 34, information is transmitted to plug-in 3.1 which allows it to access the required quantity at the relevant location during the execution of its processes. Thus there is a provision, for example, to store a pointer 13 in first plug-in 3.1 (cf. FIG. 1), which refers to a memory area 14 in one of the other plug-ins 3.2. In memory area 14, the quantity required by first plug-in 3.1 is stored by the other plug-in 3.2 and possibly regularly updated. In plug-in 3.1, a field 15 is provided for pointer 13 in which the target address of pointer 13 may be stored. For other quantities required by plug-in 3.1 for executing the processes, additional fields 16 are provided, which may also be used for storing pointers to memory areas, where the required quantities may be retrieved during the execution of the processes.

Alternatively it is also possible, however, that only a single field 17 is reserved in a plug-in, for example in plug-in 3.3, even though several quantities are required in the processes of plug-in 3.3. Field 17 stores the address of a pointer 18, which refers to a structure 19. Structure 19 may be stored in any plug-in 3.1 through 3.n or in base software 4. Specific quantities are stored in structure 19 in specified positions or in specified fields. The quantities may be stored either directly in the fields of structure 19 or additional pointers 20 may be stored in the fields, which refer to a corresponding memory area 21 in one of plug-ins 3.1 through 3.n or in base interface 2, where the required quantity is then stored.

In this case, the system jumps from plug-in 3.3 first to the beginning of structure 19 if a specific quantity is required. Depending on the required quantity, the system then jumps to the respective field of structure 19. In the exemplary embodiment shown, the system jumps into the third field of structure 19, where an address of pointer 20 to memory area 21 is stored in plug-in 3.n. From there the current value of the required quantity is retrieved. Subsequently, the execution of the interrupted process in plug-in 3.3 is continued.

The use of structures 19 makes it possible to save memory space for pointers 13, 18 in the plug-ins since instead of fields 15, 16 in plug-in 3.1 only one field in plug-in 3.3 must be held in reserve.

In a query block 35, a check is performed as to whether for all of the quantities required by plug-in 3.1 information was transmitted to plug-in 3.1 that allows it to access the quantities while executing its processes. If this is not the case, then the system branches to functional block 32, where plug-in 3.1 continues with the transmission of the next required quantity to base interface 2. The loop encompassing functional blocks 32 through 34 and query block 35 is run through until information has been transmitted to plug-in 3.1 for all of the quantities it requires.

As soon as this is the case, the system branches to another query block 36, where a check is performed as to whether all plug-ins 3.1 through 3.n connected to base interface 2 and all sub-interfaces 2.2 have informed base interface 2 as to what quantities they require for executing their processes. If this is not the case, then the system branches to functional block 31, where the next plug-in 3.2 or the next sub-interface 2.2 communicates information to base interface 2 regarding its processes. In the subsequent loop encompassing blocks 32 through 35, information is then transmitted to the next plug-in 3.2 as to where it may access the quantities it requires. The loop encompassing functional blocks 31 through 34 and query blocks 35 and 36 is run through until all of the plug-ins 3.1 through 3.n connected to base interface 2 and all sub-interfaces 2.2 have informed base interface 2 as to what quantities they require for executing their processes. As soon as this is the case, the method according to the present invention is ended in a functional block 37.

Of course, in a variation of the method shown in FIG. 3 it is also possible first to query all plug-ins 3.1 through 3.n and all sub-interfaces 2.2 regarding the quantities they require and initially to store the responses of the plug-ins 3.1 through 3.n and sub-interfaces 2.2 in a table or the like. Subsequently, all plug-ins 3.1 through 3.n and all sub-interfaces 2.2 may be queried as to what quantities they are able to provide in the context of the execution of the processes implemented in them. These quantities could also be stored in a table or the like. Subsequently, the required and provided quantities stored in the tables would have to be suitably related to each other and the plug-ins 3.1 through 3.n and the sub-interfaces 2.2 would have to be connected to one another by pointers 13, 18.

Irrespective of the particular concrete implementation of the method according to the present invention it is crucial that the plug-ins 3.1 through 3.n connected to system 1 output information regarding the functionalities they execute, that is, for example, regarding the priority, the time pattern etc. of the processes implemented in them. Likewise, plug-ins 3.1 through 3.n would have to indicate the quantities that they require for executing the processes implemented in them, and to indicate those quantities which they are able to provide by executing the processes implemented in them. All this information comes together in base interface 2 and is processed there in a suitable manner. As a result of the processing in base interface 2, plug-ins 3.1 through 3.n, which require specific quantities, receive pointers 13, 18 to memory areas 14, 21 or structures 19, where they are able to retrieve the required quantities during the execution of the processes, that is, during the run time of the computer program.

The method according to the present invention is implemented by a communications protocol, which is executed on at least one computing device of electronic system 1. A computing device is in particular a microprocessor or a microcontroller. Such a computing device for executing the communications protocol exists, for example, in base interface 2 and in each of the plug-ins 3.1 through 3.n or in sub-interfaces 2.2. When starting up system 1, in addition to the operating system, the communications protocol to be executed by the computing devices is loaded as well and is executed in a fully automatic manner. Of course, the communications protocol may also be executed after a resetting of system 1 (a so-called reset) without requiring a complete fresh start-up of system 1.

If in the context of the initialization method according to the present invention, master interface 2.1 directs a query to a sub-interface 2.2 for information regarding the executed functionalities or processes, the required quantities and the quantities provided, then sub-interface 2.2 in the context of the visibility concept relays the query to plug-ins 3.1 through 3.n connected to it.

In order to generate a functional and executable program from the various plug-ins 3.1 through 3.n and from base software 4 in the context of the initialization, the following steps are also executed during the initialization in addition to the steps described above:

The start addresses of the processes to be executed from plug-ins 3.1 through 3.n and base software 4 are entered into lists. These lists are provided by master interface 2.1 for specific task periods of the operating system (for example 10 ms). During the initialization, the processes to be called in the operating system tasks are entered into the corresponding lists of the scheduler. For intervals (for example 30 ms), dividers are computed, which start the call only during the nth task run-through (for example, every 3^{rd} time in a 10 ms task). The process lists of master interface 2.1 are entered into the task management or the entries are retrieved from there. It must also be noted that a plug-in 3.1 through 3.n does not necessarily have to include a process.

During the run time of the computer program, that is, following initialization, the plug-in functions access the quantities they require via pointers 13, 18. In order to ensure an unequivocal communication between plug-ins 3.1 through 3.n, all quantities are referenced via a unique identifier, a so-called identification number ID.

These identifiers contain details regarding the physical content, the unit, the data type as well as conversion formulas of the respective quantities. This presupposes a central location, however, which coordinates or manages all available identifiers. The coordination or management of all available identifiers is performed by base interface 2 using access to identifier list 5.

The initialization method according to the present invention has some essential advantages:

On the one hand it results in substantial time savings at the time of the integration of the various plug-ins. If one or several of the plug-ins are supplied by a supplier, the supplier has the responsibility to structure the plug-ins according to the visibility concept presented above. At the time of integration, only the plug-in remains to be integrated into the rest of system 1. Master interface 2.1 takes care of everything else during initialization in a fully automatic manner. That is to say, the integrator no longer has to make any adjustments to the rest of system 1 (as for example the integration of processes or the like). The system structure according to the present invention may be used, for example, for a control unit, in particular for a motor vehicle control unit (e.g. an engine control unit), on which applications, or functionalities, from various suppliers are integrated.

Subsequent upgrades, that is, a subsequent loading of functionalities into a control unit in the field, are possible without having to program (flash) the control unit anew in its entirety. The system concept presented above allows for the subsequent flashing of functionalities. In this connection, subsequent means that a customer may download new program parts in the manner of a “software fueling station”. At a suitable loading device, for example, at a fueling station or a service station, a desired functionality may be downloaded (flashed) into a defined area of the control unit. Following the initialization according to method of the present invention, this functionality is available in the entire system 1 or in the vehicle without the customer having to intervene in any way.

What is claimed is:

1. A method for initializing an electronic system (1) comprising at least one base interface (2) and several module-like plug-ins (3.1, . . . 3.n) connected to it, wherein
in initializing the electronic system (1), the plug-ins (3.1, . . . 3.n) provide information to the base interface (2) regarding:
at least one functionality implemented by the respective plug-in (3.1, . . . 3.n);
quantities required by the respective plug-in (3.1, . . . 3.n) for implementing the at least one functionality;
quantities provided by the respective plug-in (3.1, . . . 3.n) following the implementation of the at least one functionality,
the base interface (2) provides information to the individual plug-ins (3.1, . . . 3.n) regarding:
which of the remaining plug-ins (3.1, . . . 3.n) provides a quantity required by the plug-in (3.1, . . . 3.n), and
a corresponding reference to the plug-in (3.1, . . . 3.n) providing the quantity is stored in the plug-in (3.1, . . . 3.n) that requires the quantity.

2. The method as recited in claim 1, wherein the at least one functionality is implemented by at least one process.

3. The method as recited in claim 2, wherein the information regarding the functionality includes a time pattern pattern for executing the at least one process and a priority of the at least one process.

4. The method as recited in one of claims 1 through 3, wherein in the plug-in (3.1, . . . 3.n) requiring a quantity, as a reference a pointer (13) to a memory location (14) is stored, in which the required quantity is stored by one of the remaining plug-ins (3.1, . . . 3.n).

5. The method as recited in one of claims 1 through 3, wherein in the plug-in (3.1, . . . 3.n) requiring a quantity, as a reference a pointer (18) to a structure (19) is stored, in which at a specified position the required quantity is stored by one of the remaining plug-ins.

6. The method as recited in claim 2 or 3, wherein if a specific quantity is provided by several plug-ins (3.1, . . . 3.n), the quantity of that plug-in (3.1, . . . 3.n) is utilized for further processing whose process has the highest priority for ascertaining the quantity.

7. The method as recited in one of claims 1 through 5, wherein if a specific quantity is provided by several plug-ins (3.1, . . . 3.n), the quantity of that plug-in (3.1, . . . 3.n) is utilized for further processing which is the first to inform the base interface (2) that the plug-in (3.1, . . . 3.n) or a process of the plug-in (3.1, . . . 3.n) is able to provide the require quantity.

8. The method as recited in one of claims 1 through 5, wherein if a specific quantity is provided by several plug-ins (3.1, . . . 3.n), the quantity of that plug-in (3.1, . . . 3.n) is utilized for further processing which is the last to inform the base interface (2) that the plug-in (3.1, . . . 3.n) or a process of the plug-in (3.1, . . . 3.n) is able to provide the require quantity.

9. The method as recited in one of claims 1 through 8, wherein the base interface (2) has access to an initialization table (22) containing information as to where the individual plug-ins (3.1, . . . 3.n) are stored.

10. A method for initializing an electronic system (1) comprising at least one base interface (2) and several module-like plug-ins (3.1, . . . 3.n) connected to it, in particular as recited in one of claims 1 through 9, wherein one of the base interfaces (2) is configured as a master interface (2.1) and the remaining base interfaces (2) are configured as sub-interfaces (2.2), the master interface (2.1) having, in addition to the plug-ins (3.1, . . . 3.n), sub-interfaces (2.2) connected to it to which in turn additional sub-interfaces (2.2) and/or additional plug-ins (3.1, . . . 3.n) and so on are connected, the interfaces (2.1, 2.2) being divided into different areas (11, 12) and only the quantities applied within the same area of the interfaces (2.1, 2.2) being visible for subordinate interfaces (2.1, 2.2).

11. The method as recited in claim 10, wherein the interfaces (2.1, 2.2) are divided into a private area (12) and a public area (11) and only the public quantities applied in the public area (11) of an interface (2.2) are visible for a subordinate interface (2.1, 2.2).

12. The method as recited in one of claims 1 through 11, wherein each quantity required by the plug-ins (3.1, . . . 3.n) or provided by the plug-ins (3.1, . . . 3.n) is assigned an identifier (Id i) that is unique for a defined area of the electronic system (1).

13. The method as recited in claim 12, wherein the identifiers (ID i) of the quantities are stored in an identifier list (5), which the base interface (2) is able to access during the initialization of the electronic system (1).

14. A communications protocol for execution on at least one computing device of an electronic system (1), comprising at least one base interface (2) and several module-like plug-ins (3.1, . . . 3.n) connected to it, during the initialization of the electronic system (1), wherein the communications protocol is programmed in such a way that
in initializing the electronic system (1), the plug-ins (3.1, . . . 3.n) provide information to the base interface (2) regarding: + at least one functionality implemented by the respective plug-in (3.1, . . . 3.n);
quantities required by the respective plug-in (3.1, . . . 3.n) for implementing the at least one functionality;
quantities provided by the respective plug-in (3.1, . . . 3.n) following the implementation of the at least one functionality,
the base interface (2) provides information to the individual plug-ins (3.1, . . . 3.n) regarding:
which of the remaining plug-ins (3.1, . . . 3.n) provides a quantity required by the plug-in (3.1, . . . 3.n), and
a corresponding reference to the plug-in (3.1, . . . 3.n) providing the quantity is stored in the plug-in (3.1, . . . 3.n) that requires the quantity.

15. A computer program for execution on a computing device of a data processing system, the computer program comprising at least one base interface (2) and several plug-ins (3.1, . . . 3.n) connected to it, wherein
in initializing the computer program, the plug-ins (3.1, . . . 3.n) provide information to the base interface (2) regarding:
at least one functionality implemented by the respective plug-in (3.1, . . . 3.n),
quantities required by the respective plug-in (3.1, . . . 3.n) for implementing the at least one functionality, and
quantities provided by the respective plug-in (3.1, . . . 3.n) following the implementation of the at least one functionality;
the base interface (2) provides information to the individual plug-ins (3.1, . . . 3.n) regarding:
which of the remaining plug-ins (3.1, . . . 3.n) provides a quantity required by the plug-in (3.1, . . . 3.n); and
a corresponding reference to the plug-in (3.1, . . . 3.n) providing the quantity is stored in the plug-in (3.1, . . . 3.n) that requires the quantity.

16. An electronic system (1) having a computing device for executing a communications protocol, the electronic system (1) comprising at least one base interface (2) and several module-like plug-ins (3.1, . . . 3.n) connected to it, wherein
in the process of initializing the electronic system (1), the plug-ins (3.1, . . . 3.n) provide the base interface (2) with information regarding:
at least one functionality implemented by the respective plug-in (3.1, . . . 3.n);
quantities required by the respective plug-in (3.1, . . . 3.n) for implementing the at least one functionality;
quantities provided by the respective plug-in (3.1, . . . 3.n) following the implementation of the at least one functionality,
the base interface (2) provides information to the individual plug-ins (3.1, . . . 3.n) regarding:
which of the remaining plug-ins (3.1, . . . 3.n) provides a quantity required by the plug-in (3.1, . . . 3.n), and
a corresponding reference to the plug-in (3.1, . . . 3.n) providing the quantity is stored in the plug-in (3.1, . . . 3.n) that requires the quantity.
